(19) United States
(12) Patent Application Publication
(10) Pub. No.: US 2014/0111357 A1
(43) Pub. Date: Apr. 24, 2014

(54) Method and Apparatus for Alarm Control

(71) Applicant: FORD GLOBAL TECHNOLOGIES, LLC, Dearborn, MI (US)

(72) Inventors: David Anthony Hatton, Berkley, MI (US); Robert Bruce Kleve, Farmington, MI (US); Arthur Van Jack, Southfield, MI (US); Christian Krozal, Livonia, MI (US); David Randolph Roberts, Dearborn, MI (US); Joseph Carl Beiser, Northville, MI (US); Chad Evert Esselink, Canton, MI (US); Tricia Tobolski, Harrison Township, MI (US); John Robert Van Wiemeersch, Novi, MI (US)

(73) Assignee: FORD GLOBAL TECHNOLOGIES, LLC, Dearborn, MI (US)

(21) Appl. No.: 13/656,951

(22) Filed: Oct. 22, 2012

(51) Int. Cl. G08G 1/123

(52) U.S. Cl. 340/991

(57) ABSTRACT

A system includes a processor in communication with a vehicle computing system (VCS) and a remote target. The processor is configured to receive an alarm message from the VCS, including GPS coordinates. The processor is further configured to interpret the alarm message to retrieve at least the GPS coordinates. The processor is also configured to perform reverse geocoding on the GPS coordinates to associate an address with the GPS coordinates. Also, the processor is configured to package the address in a new alarm message. Finally, the processor is configured to send the new alarm message to the remote destination target

### TECHNICAL FIELD

The illustrative embodiments generally relate to a method and apparatus for alarm control.

### BACKGROUND

Personal attack in and around vehicles are becoming more and more commonplace in certain areas of the world. People are experiencing kidnappings, car-jackings, and other assaults while driving or otherwise using their vehicles. Victims experiencing these personal emergencies may wish to call someone for help. In some cases, they may have access to their phone and be able to use it and dial for help. In other cases, however, the phone may be unavailable, or the driver may be unable to use the phone for safety reasons.

Although alarm systems for vehicles exist, such as panic systems, it may be undesirable to alert an assailant that an alarm has been triggered. Whether a “panic” style alarm or one that notifies the police, alarm triggering may cause an assailant to escalate actions towards the victim.

U.S. Pat. No. 8,013,734 generally discusses a method of alarm notification. An alert mode of a mobile device is activated based on an emergency situation in an area. The mobile device transmits an indication of the emergency situation to a communication network control system. The communication network control system confirms the indication of the emergency situation to the mobile device and notifies emergency personnel of the indication of the emergency situation. The communication network control system transmits an indication of the emergency situation to one or more additional mobile devices in the area.

U.S. patent application Ser. No. 12/368,947 generally discusses methods and apparatus for providing useful data in association with a high-priority call such as an emergency call. In one embodiment, the data comprises a data (e.g., an MSD or FSD) embedded within one or more real-time protocol packets such as RTP Control Protocol (RTCP) packets, that are interspersed within the voice or user data stream (carried in e.g., RIP packets of an emergency call. Apparatus and methods are described for transmitting the data portion reliably from the initiating terminal (e.g., an in-vehicle system) to a Public Safety Answering Point CPSAP), by using the same transport connection as the user data.

### SUMMARY

In a first illustrative embodiment, a system includes a processor in communication with a vehicle computing system (VCS) and a remote target. The processor is configured to receive an alarm message from the VCS, including GPS coordinates. The processor is further configured to interpret the alarm message to retrieve at least the GPS coordinates. The processor is also configured to perform reverse geo-coding on the GPS coordinates to associate an address with the GPS coordinates. Also, the processor is configured to package the address in a new alarm message. Finally, the processor is configured to send the new alarm message to the remote destination target.

In a second illustrative embodiment, a computer-implemented method includes receiving an alarm message from a vehicle computing system (VCS), including vehicle GPS coordinates. The method further includes interpreting the alarm message to retrieve at least the GPS coordinates and performing reverse geo-coding on the GPS coordinates to associate an address with the GPS coordinates. Also, the method includes packaging the address in a new alarm message and sending the new alarm message to the remote destination target.

In a third illustrative embodiment, a computer readable storage medium stores instructions that, when executed by a processor of a vehicle computing system, cause the vehicle computing system to perform the method including receiving an alarm message from a vehicle computing system (VCS), including vehicle GPS coordinates. The exemplary method also includes interpreting the alarm message to retrieve at least the GPS coordinates and performing reverse geocoding on the GPS coordinates to associate an address with the GPS coordinates. Also, the method includes packaging the address in a new alarm message and sending the new alarm message to the remote destination target.

### BRIEF DESCRIPTION OF THE DRAWINGS

FIG. 1 shows an illustrative vehicle computing system;

FIGS. 2a-b show an illustrative example of one alarm activation and processing flow utilizing interactive voice response (IVR);

FIGS. 3a-b show another illustrative example of one alarm activation and processing flow utilizing data over voice (DOV);

FIG. 4 shows an illustrative example of yet another alarm activation and processing flow utilizing a voice call;

FIG. 5 shows an illustrative example of a further alarm activation and processing flow utilizing a SMS;

FIG. 6 shows an illustrative example of yet another alarm activation and processing flow utilizing a tracking and blocking module (TBM); and

FIG. 7 shows an illustrative example of yet another alarm activation and processing flow utilizing an API protocol.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

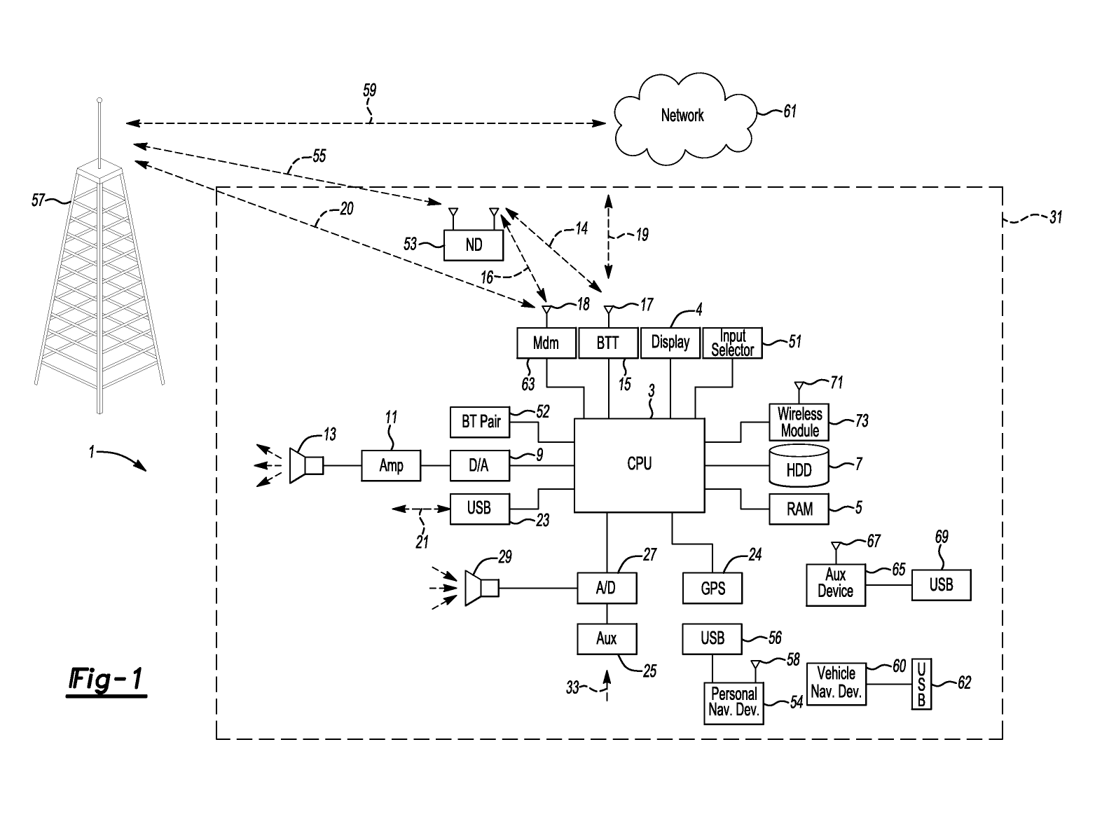

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In at least one illustrative embodiment, the silent alarm is realized through a triggering device. This device may be, for example, without limitation, carried by a person or attached by a customer to a surface in the vehicle. The device may have a triggering button that sends a message (such as in the non-limiting examples herein) when activated. Secondary triggering may also be enabled, for example, through steering wheel controls.

In at least some embodiments, feedback may be provided through devices such as, but not limited to, LED displays and/or a nav/radio head unit display. Triggered alarms signals may be send to one or more off-board points of contact through various methods, and may include, for example, vehicle location information and other relevant information. The message may further be repeated at certain intervals or distance changes. In other embodiments, feedback may not be provided which can relate to “silent” alarms.

A variety of off-board actions can be implemented when an alarm message is triggered. For example, in a first process, various methods of actually sending the notification can be implemented. These include, but are not limited to, contacting an automated server, a live call center, 911/police directly, social media sites and/or a phone number. A variety of transport mechanisms may also be implemented, including, but not limited to, voice DTMF, voice DOV, a voice call, an SMS/text message, a mobile application and/or a data connection.

Further, one or more intermediary routing steps may occur. These steps can include, but are not limited to, routing through a server, a call center, a human operator or a social media server. Finally, in this generalization of an exemplary, illustrative process, one or more end-point contacts can receive the following forms of communication, including, but not limited to, a voice call, a mobile application notification, a social media update, an email and/or a SMS or text message.

In one illustrative example, a voice call can include data sent over voice, for example, if data transfer is desired. Or a dual-tone multi-frequency message can be provided, which can use tones to indicate certain variables or signals for an alarm (or respond to an automated system). An audio file could be sent, and in some examples the vehicle computing system can generate a voice message for transmission. In another example, if a data connection is established, emails, location sharing services and data packets can be utilized/sent for alarm notification purposes. A mobile application can be used, for example, to send a text or data packet, make a phone call, etc.

In addition, intermediary information may be added at any point along the line as the alarm is routed to a destination. For example, without limitation, at the vehicle, as the message is initiated/generated/sent, in case of emergency (ICE) information may be saved/pulled from a connected phone, for use in routing a primary or secondary message. Additionally, for example, reverse geo-coding may be done by a vehicle nav system, and/or directions may be added to a message by the nav system. Similarly, this information may be added by a user's phone at the origin point. Reverse geo-coding can include, but is not limited to, determining reference landmarks, distance and direction to those landmarks, cross-street locations/directions, current vehicle address/location and any other appropriate geographical data relating to a vehicle position.

Once the message passes to a server for routing, saved ICE information and/or routing information may be added at that point. Finally, at an ICE contact location, reverse geocoding and/or directions may be added to the message based on, for example, a transmitted GPS location of a vehicle.

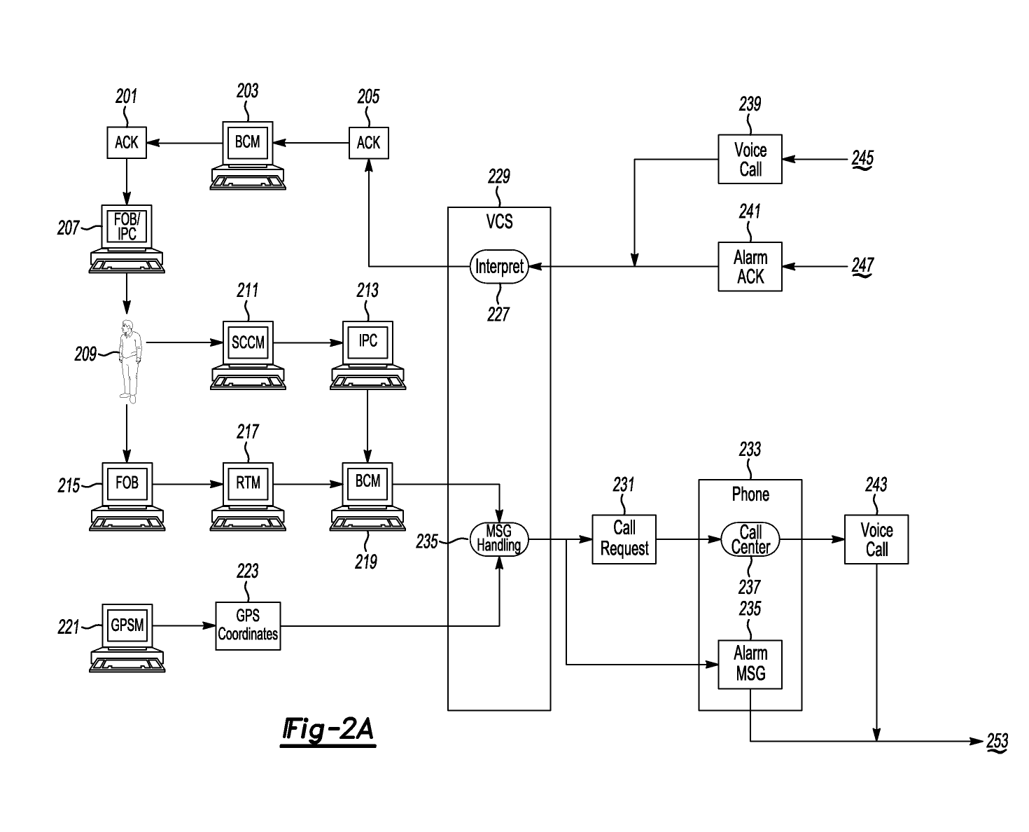

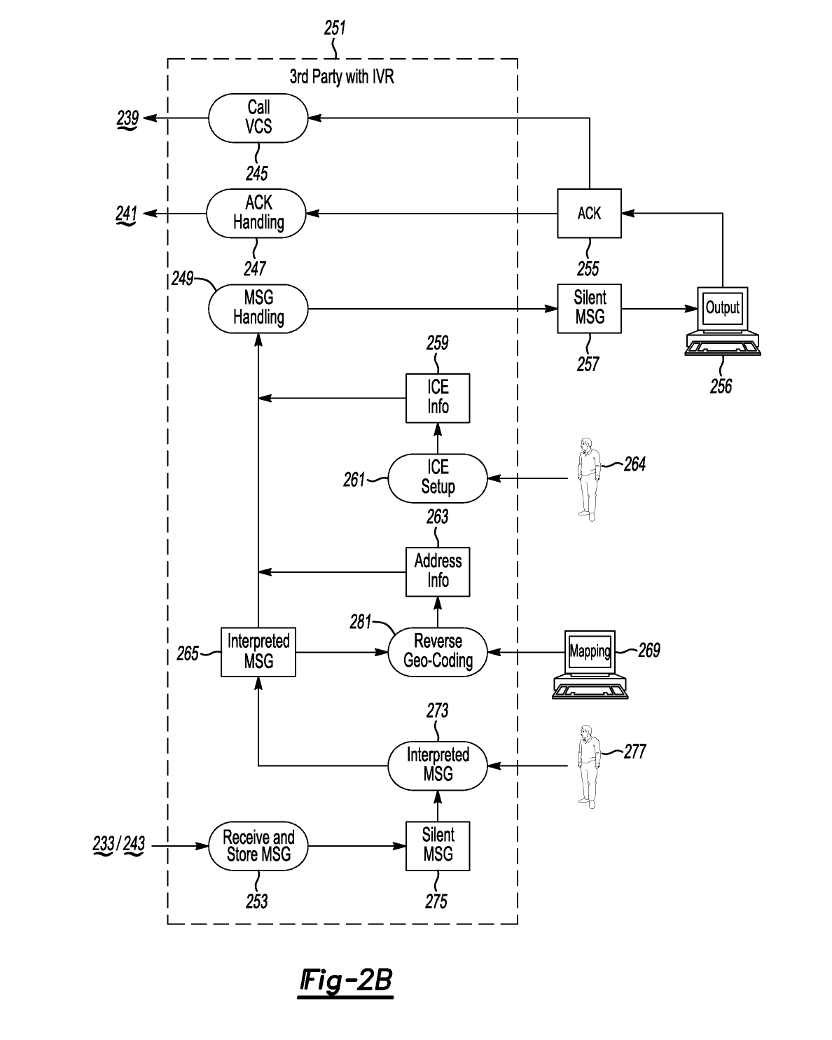

FIGS. 2a-b show an illustrative example of one alarm activation and processing flow utilizing interactive voice response (IVR). In this example, after a silent alarm is sent, an acknowledgement 205 may be received from a contacted source at a bluetooth control module (BCM). The acknowledgement 201 may be forwarded to a key fob or IPC, to notify a user 209 that the alarm had been received. The user may be the same user who initiated the alarm, which could have been initiated through a variety of sources, such as, but not limited to, a steering column control module (SCCM) (switch) 211, IPC 213, a key fob 215, a radio transceiver module (RTM) 217. The alarm may be routed through a BCM and send to message handling 225 within the VCS 229. In addition, the vehicle GPSM (GPS module) may send GPS coordinates to the message handling process.

Another message handling process within the VCS may receive an incoming voice call 239 and/or alarm acknowledgement 241. This process can relay the acknowledgement and any voice call to the appropriate vehicle/user systems.

The message handling process 225 may initiate a call request, such as a voice call to pass voice or data over voice to an intermediary or end destination. In addition or alternatively, the process may utilize a cell phone to send a silent alarm message (such as data or a text message) 235. The same cell phone 233 may also be used to place a call to, for example, a call center 237. The voice call 243 and/or alarm message data may be sent to a 3^{rd} party. In this example, the 3^{rd} party has interactive voice response IVR technology provided thereto.

The 3^{rd} party, in this example, may receive and store any alarm message 253 and/or voice data, such as an IVR message 275. The IVR message may then be interpreted, for example, through use of IVR software at the 3^{rd} party 273. A live operator 277 may also be used to interpret the IVR message. Once interpreted, the interpreted message 265 may be formatted with reverse geocoding 271, which can draw data from a mapping engine 269.

The reverse geo-coding may include addition of an address 263 for the vehicle, based on, for example, GPS coordinates provided as part of the message. ICE information 259 may be added. At some point prior to the alarm activation, a customer 267 may have set up the ICE information 261. All of this information may be sent to a message handling process within the 3^{rd} party provider.

The message handling process may then generate and send a message 257 to one or more various end-point outputs 256. These outputs can include, but are not limited to, SMS outputs, social messaging sites, e-mail, a voice call, a mobile application, etc. Transmission of the message can also result in generation of an acknowledgement message 255. The acknowledgement message may be passed back to the 3^{rd} party location for processing. The 3^{rd} party location may then take actions such as calling the VCS 245. Also, acknowledgement message handling 241 may be done to pass along an acknowledgement, to be directed back to the alarm originator.

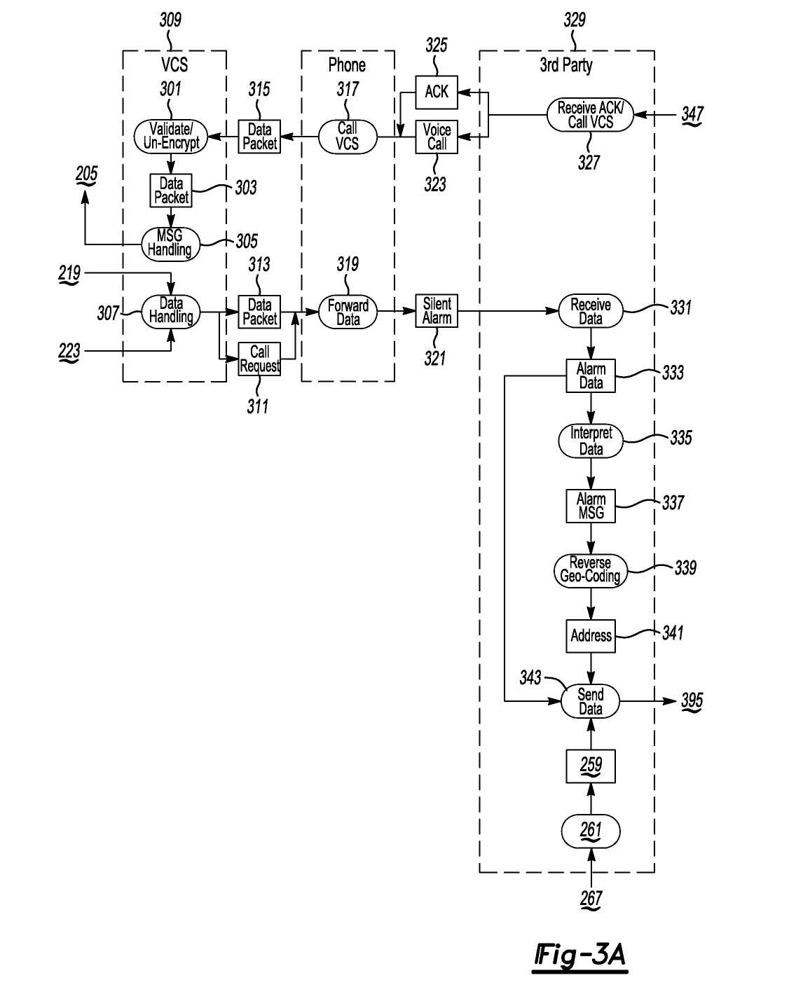

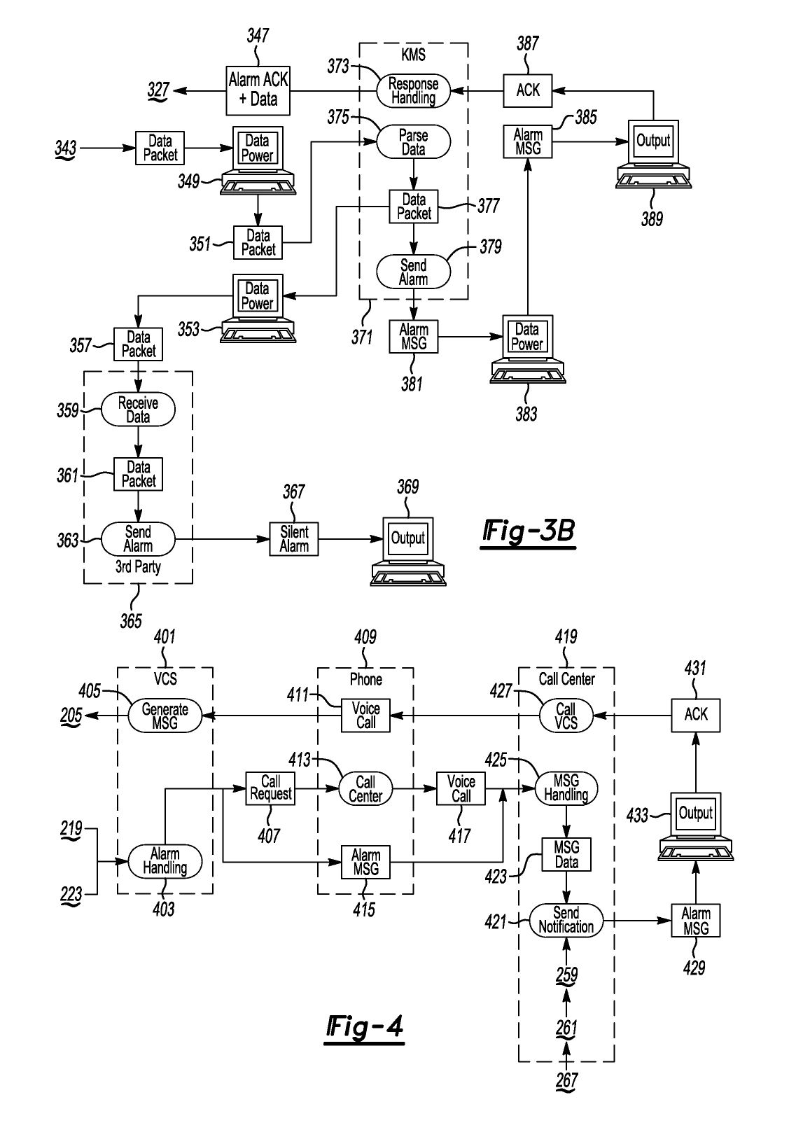

FIGS. 3a-b show another illustrative example of one alarm activation and processing flow utilizing data over voice (DOV). In this illustrative example, the vehicle computing system may send an encrypted message using DOV. Once the alarm has been initiated and send to the VCS for processing, the data handling mechanism may take over 307. In this example, the data handling process may include initiating, building, encoding and sending a data packet.

Similarly, any incoming acknowledgement may also be encrypted and/or signed. In this example, the VCS may receive the message and validate/unencrypt the acknowledgement 301. This can result in a data packet, containing, for example, an acknowledgement. A message handling process within the VCS can then handle 305 the acknowledgement and send it to the appropriate device/output for delivery to the user.

In this example, the data handling process (for outgoing alarm data) may generate a data packet 313 and/or a call request 311. This data/request can be sent to a cell phone, from where it can be forwarded 319 to an appropriate end party or intermediary. In this illustrative example, the silent alarm data 321 is sent to an OEM processing server or 3^{rd} party intermediary, where the data packet(s) is received 331. At this point, the data packet may have additional information added thereto. For example, without limitation, the process may access the silent alarm data packet 333 and interpret the data contained therein 335. Utilizing this data 337, the process may, for example, perform reverse geo-coding on the GPS data to include location-relevant information relating to the vehicle 339. This data can include, but is not limited to, a vehicle address 341.

As before, ICE information may also be sent out with the data packet, to designate a primary or secondary end-user to contact. For example, a primary end contact may be the police, but one or more ICE 3^{rd} parties may also wish to be notified in the event of an alarm, and the ICE data can designate parties to be notified and conditions under which to notify those parties. All relevant data/augmented data can then be sent out for further processing and delivery 343.

In this illustrative example, the data packet 345 is sent to data power processor 349, which can process and relay the data 351 to a KMS system 371. At the KMS, the data can be parsed to retrieve relevant information and routing information 375. In this example, once the information has been parsed, several steps can occur.

A data packet 377 can be sent to two different (or more) locations. Here, the packet goes back to the data power engine 353 and the packet 357 is then relayed to a 3^{rd} party router. The router 365 receives the data 359 and takes an unsigned version of the data 361 to generate a silent alarm. The silent alarm 363 is sent as data to a 3^{rd} party, for example, to be output to an appropriate device 369.

Additionally, the KMS may send 379 the alarm data 377 as an alarm message to the data power engine for relay to another receiver, such as, but not limited to, an emergency operator or other law enforcement/safety official. The alarm message 385 is output in an appropriate format, and then, if desired, an acknowledgement 387 can be sent. The acknowledgement, in this embodiment, passes back to KMS. At KMS, a process builds, encodes and sends a response 373, such as, but not limited to, a DOV response. The alarm data 347 can then be sent back to the intermediary server, where the server can receive the acknowledgement 327 and call the VCS.

From the intermediary server, the acknowledgement 325 and/or any voice call 323 can be sent to the user's phone. The user's phone can then contact the VCS 317, where the data packet 315 is passed back to the VCS for decryption and handling.

FIG. 4 shows an illustrative example of yet another alarm activation and processing flow utilizing a voice call. In this example, the voice call is a VCS generated voice call to a live call center. In this illustrative example, after a silent alarm has been activated the alarm and any relevant GPS information can be processed by the VCS 401.

The VCS, in this example, initiates, builds and sends a silent alarm through an alarm handling process 403. The alarm can include a cell phone call request 407, in this example, because a voice call will be placed. The call request is sent to a cell phone 409 for processing, along with any alarm message data 415. The cell phone can dial the call center 413 as per the call request instructions, to pass along the voice message 417.

At the call center, both the voice message 417 and any alarm data 415 (sent as, for example DOV) are received and interpreted 425. Interpreted message data 423 is extracted for further processing. The interpreted message data can include data from the data packets and/or data received from the voice call. This interpreted data will then be sent out to a notification party 421, along with and ICE data for identifying the notification party or a secondary recipient.

The alarm message is sent to a notification party for output in an appropriate format 433, and a confirmation/acknowledgement 431 can be sent back to the call center. Once the confirmation has been receieved at the call center, the call center can call the VCS 427, contacting the VCS, for example, through a call to the cell phone. The voice call 411 is passed through the cell phone to the VCS, and the VCS can then generate a confirmation message 405.

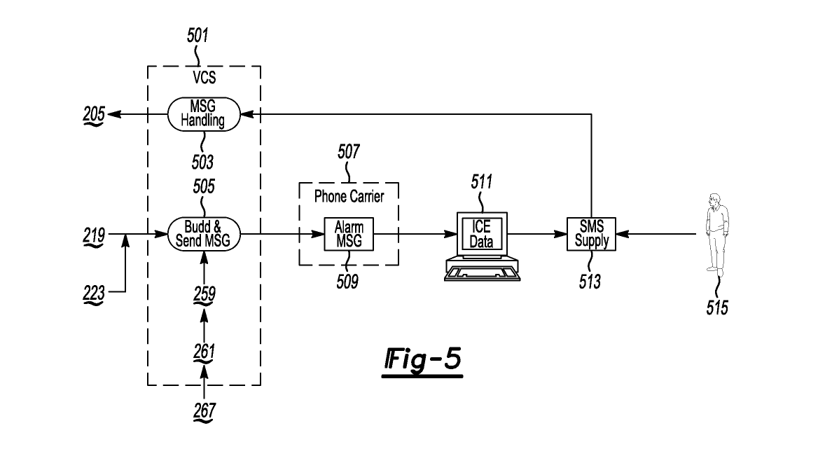

FIG. 5 shows an illustrative example of a further alarm activation and processing flow utilizing a SMS. In this illustrative example, the silent alarm is triggered and any relevant GPS data can be included in a flow to the VCS. The VCS receives the message and builds and sends an emergency SMS/text message 505. The text message may also include any relevant data, such as, but not limited to ICE data. The ICE data can further be used to identify one or more recipients for the text message.

The SMS 509 is then sent to a cell phone carrier 507, from which it can be relayed to the cell phone of an ICE contact 511. The message can also request a reply 513, which will be input by the recipient 515 and can be sent as a text message back to the VCS 503, where the message can be handled appropriately 503 and relayed as an acknowledgement if desired.

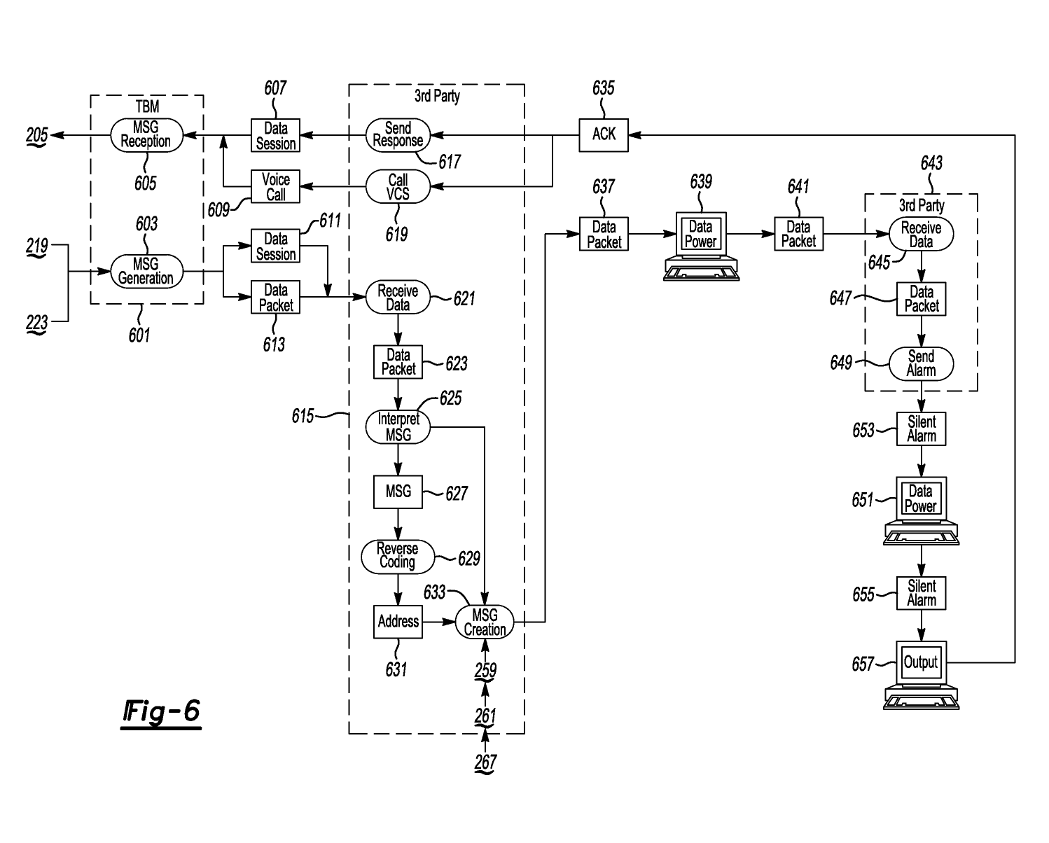

FIG. 6 shows an illustrative example of yet another alarm activation and processing flow utilizing a tracking and blocking module (TBM). The tracking and blocking module can be used to track and disable the vehicle remotely. A tracking and blocking module is included in this system for handling of outgoing alarms and incoming acknowledgements and other data. In this illustrative example, once the alarm has been triggered, the alarm notification along with relevant GPS data may be sent to the tracking and blocking module 601. The TBM initiates, builds, encodes and sends the silent alarm message 603. This can be done through the use of an embedded modem included with the tracking and blocking module, including, for example, a customer-paid and activated plan associated with the module for communication usage purposes.

A data session 611 can be established with a 3^{rd} party routing service 615, and a data packet 613 including the alarm information can be sent thereby. The 3^{rd} party service can receive the data and store the data packet for later retrieval 621. The data packet 623 can then be passed along for further processing. The interpreted message 627 can have reverse geo-coding 629 included therewith, such as, but not limited to, the inclusion of an address 631 where the vehicle is currently located. Alternatively, the interpreted message can be sent 625 to a message creation process 633, which can then include/utilize any previously stored ICE data for routing the silent alarm message.

The message creation process can then sent a silent alarm data packet 637 to a data power engine 639, which can relay the data packet 641 to an OEM server or 3^{rd} party 643 for handling of the message. The server receives the message 645, extracts the data packet 647 and sends the alarm to the appropriate end-use party. The sent message 653 can go through another data power engine and the silent alarm 655 can be output 657 at the end-party's device. A confirmation message 35 may also TBM generated and sent back to the 3^{rd} party that handled the original message for relay back to the VCS.

The data power engine is an OEM back-end system that can store information such as, but not limited to, customer information, VIN information, and other customer/vehicle specific data that can be added to the alarm to provide a more useful alarm signal with as much specific data as possible.

The 3^{rd} party 615, upon receiving the responsive confirmation message, can send a response to the TBM 617, and can also call the TBM utilizing a voice call if desired 619. In this manner, a data session 607 and/or a voice session 609 can be established for communication with the TBM. A message reception function 605 can receive any incoming information and generate appropriate acknowledgements and CAN bus messages to handle the incoming information accordingly.

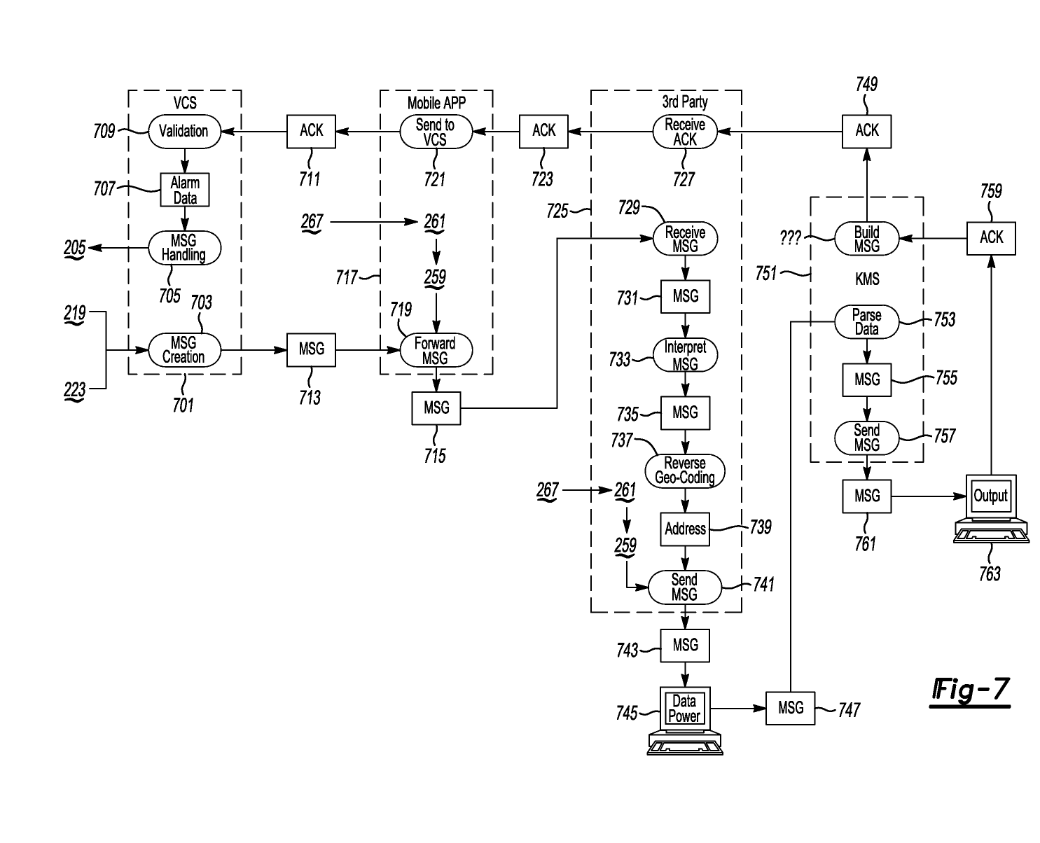

FIG. 7 shows an illustrative example of yet another alarm activation and processing flow utilizing an API protocol. In this illustrative embodiment, a VCS 701 is used in conjunction with one or more mobile applications to relay a silent alarm message. Once an alarm has been triggered, the alarm may be sent (again with any desired GPS data) to the VCS for processing. The VCS receives the alarm notification, and initiates, builds, encodes (if necessary) and sends 703 the silent alarm message 713 to a mobile application 717. In this embodiment, the mobile application may be responsible for adding/utilizing any ICE data to the message, as well as adding GPS data if the data has not already been provided. Based on one or more ICE contacts, the mobile application can forward 719 the silent alarm message 715 to be received by a 3^{rd} party (e.g., cloud-routing) and sent to an appropriate destination.

At the cloud, the message is received 729. The silent alarm message 731 is then passed to an interpretation process 733. The interpreted message 735 may then be subjected to reverse geo-coding 737 for addition of an address 739 to the message. An alarm message 741 may then be sent, utilizing the appropriate ICE information as an addition to the message and/or as a resource for routing.

The message 743 may be sent to the data power engine 745 for addition of user/vehicle specific details known to an OEM, and the further augmented message 747 may be sent to a KMS. The KMS can unsign the message and parse the data packet 753, resulting in an unsigned silent alarm message 755. This message is then sent by the KMS 757. The message sent by the KMS 761 can be delivered to the appropriate recipient 763, and a confirmation/acknowledgement 759 can be sent back to the KMS.

Upon receiving the acknowledgement, the KMS can build, encode and send a response 727 back to the cloud. The response 723 is received by the cloud, which can determine which mobile app to route the acknowledgement back to. The confirmation 723 is then sent back to the mobile application, which can receive the confirmation 721 and pass the confirmation 711 down to the VCS. The VCS can then validate a signature (from the KMS) associated with the confirmation, and pass the acknowledgement back to an applicant as desired.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor in communication with a vehicle computing system (VCS) and a remote target, configured to:
receive an alarm message from the VCS, including GPS coordinates;
interpret the alarm message to retrieve at least the GPS coordinates;
perform reverse geo-coding on the GPS coordinates to associate an address with the GPS coordinates;
package the address in a new alarm message; and
send the new alarm message to the remote destination target.

2. The system of claim 1, wherein the alarm message is encoded.

3. The system of claim 1, wherein the processor is further configured to retrieve in case of emergency (ICE) information from a storage associated with the processor and forward the message to at least once ICE contact.

4. The system of claim 1, wherein the processor is further configured to retrieve in case of emergency (ICE) information from a storage associated with the processor and include information relating to at least one ICE contact in the new alarm message.

5. The system of claim 1, wherein the processor is further configured to receive an acknowledgement from the remote target that the new alarm message was received.

6. The system of claim 5, wherein the processor is further configured to send the acknowledgement to the VCS.

7. The system of claim 1, wherein the processor periodically receives updated messages from the VCS, sent based at least in part on a passage of time or vehicle change in position.

8. A computer-implemented method comprising:
receiving an alarm message from a vehicle computing system (VCS), including vehicle GPS coordinates;
interpreting the alarm message to retrieve at least the GPS coordinates;
performing reverse geo-coding on the GPS coordinates to associate an address with the GPS coordinates;
packaging the address in a new alarm message; and
sending the new alarm message to the remote destination target.

9. The method of claim 8, wherein the alarm message is encoded.

10. The method of claim 8, further including retrieving in case of emergency (ICE) information from a storage associated with the processor and forwarding the message to at least once ICE contact.

11. The method of claim 8, further including retrieving in case of emergency (ICE) information from a storage associated with the processor and including information relating to at least one ICE contact in the new alarm message.

12. The method of claim 8, further including receiving an acknowledgement from the remote target that the new alarm message was received.

13. The method of claim 12, further including sending the acknowledgement to the VCS.

14. The method of claim 13, further including encoding the acknowledgement before sending the acknowledgement to the VCS.

15. A computer readable storage medium storing instructions that, when executed by a processor of a vehicle computing system, cause the vehicle computing system to perform the method comprising:
receiving an alarm message from a vehicle computing system (VCS), including vehicle GPS coordinates;
interpreting the alarm message to retrieve at least the GPS coordinates;
performing reverse geo-coding on the GPS coordinates to associate an address with the GPS coordinates;
packaging the address in a new alarm message; and
sending the new alarm message to the remote destination target.

16. The computer readable storage medium of claim 15, wherein the alarm message is encoded.

17. The computer readable storage medium of claim 15, wherein the method further includes retrieving in case of emergency (ICE) information from a storage associated with the processor and forwarding the message to at least once ICE contact.

18. The computer readable storage medium of claim 15, wherein the method further includes retrieving in case of emergency (ICE) information from a storage associated with the processor and including information relating to at least one ICE contact in the new alarm message.

19. The computer readable storage medium of claim 15, wherein the method further includes receiving an acknowledgement from the remote target that the new alarm message was received.

20. The computer readable storage medium of claim 19, wherein the method further includes sending the acknowledgement to the VCS.
